(19) United States
(12) Patent Application Publication
(10) Pub. No.: US 2014/0257940 A1
(43) Pub. Date: Sep. 11, 2014

(54) Methods for Generating Organization Synergy Values

(71) Applicant: OrgSpan, Inc., Durham, NC (US)

(72) Inventor: Dennis Crenshaw, Durham, NC (US)

(73) Assignee: ORGSPAN, INC., Durham, NC (US)

(21) Appl. No.: 14/200,331

(22) Filed: Mar. 7, 2014

Related U.S. Application Data
(60) Provisional application No. 61/773,869, filed on Mar. 7, 2013.

(51) Int. Cl. G06Q 10/06

(52) U.S. Cl. CPC G06Q 10/06398
USPC 705/7.42

(57) ABSTRACT

Methods for generating organization synergy values are described. In one embodiment, a project may be created in a project management application, and a rating trigger associated with the project may be created. A rating triggering event may be detected, and a rating request may be generated. A completed rating associated with a project element may be received from a project stakeholder, and an organization synergy value associated with the organization member and the project element may be generated based at least in part on the rating.

### CROSS-REFERENCE TO RELATED APPLICATIONS

This application claims priority to U.S. Provisional Application No. 61/773,869 filed 7 Mar. 2013 and entitled “METHODS FOR GENERATING ORGANIZATION SYNERGY VALUES”, the contents of which are incorporated herein as if set forth in full.

### FIELD

This invention relates generally to enterprise social media applications, and more specifically to methods for generating organization synergy values.

### BACKGROUND

The success of an organization relies on the ability of its members to work together as a group to accomplish goals that would have been difficult or impossible to accomplish individually. Thus, the effectiveness of an organization is closely connected with how well project teams are assembled and how well team members work with each other. Conventional team building methods, however, are imprecise and frequently ineffective.

Managers and team leaders have limited tools for evaluating an individual's likelihood of success on a new project or for predicting how well potential team members will work together. Under conventional methods, managers may build teams based on their own limited observations and informal word-of-mouth regarding how well different team members work together, and what types of projects each person is best suited for. Through such haphazard team building, managers may overlook organization members particularly suited for a job, or worse construct teams destined to suffer from internal conflict.

Therefore there is a need for generating organization synergy values.

### SUMMARY

Embodiments provide methods for generating organization synergy values. In one embodiment, ratings are collected from organization members and used to generate and update organization synergy values. During the course of a project, organization members working on the project may update their status and report on the progress of the project through regular status reports. When the project reaches a predetermined milestone, such as a 25% completion, 50% completion, or 100% completion, a request for an evaluation, or a ratings request, may be automatically generated and sent to each team member. Each team member may submit a rating of the project itself and other team members. Using the completed ratings, organization synergy values may be generated for each team member. An organization synergy value may reflect how well an organization member works with another organization member or how compatible an organization member is with an aspect of the project.

In another embodiment, a method for generating an organization synergy value may comprise the steps of creating a project in a project management application and creating a rating trigger associated with the project. The method further comprises detecting a rating triggering event and generating a rating request. A completed rating associated with a project element may be received from a project stakeholder, and an organization synergy value associated with the organization member and the project element may be generated based at least in part on the rating.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate the present invention and, together with the description, serve to explain the principles of the invention and to enable a person skilled in the pertinent art to make and use the invention.

FIG. 1 is a flow chart illustrating a method according to an embodiment.

FIG. 2 is a flow chart illustrating a method according to another embodiment.

FIG. 3 is a flow chart illustrating a method according to another embodiment.

FIG. 4 is a flow chart illustrating a method according to another embodiment.

FIG. 5 is a diagram illustrating a system according to an embodiment.

### DETAILED DESCRIPTION

Embodiments provide methods for generating organization synergy values. Ratings may be requested from organization members, and used to generate organization synergy values. An organization member may rate other organization components, such as other organization members, organization resources, organization events, or organization projects. An organization synergy value may be generated from a completed rating and reflect the compatibility, or synergy, between the organization member (i.e. the rator) and the rated person or thing. As organization synergy values are updated with new ratings and become more accurate, organization synergy values may be increasingly useful for recommending organization members for a new project, or even when hiring a new employee.

In one exemplary embodiment a project management application tracks a project, such as a software release. A project may comprise a plurality of organization members (i.e. team members), and a plurality of tasks. The project management application may track a project through status updates, reports, and other manual or automatic mechanisms. During the course of the project and/or when the project is completed, a rating request is triggered in the project management application. In the example, a rating request may be automatically triggered when the project reaches a predetermined completion percentage, such as 50%. Rating requests may be triggered based on other criteria, such as manual or periodic triggers.

In the exemplary embodiment, after a rating request has been triggered, a rating request may be transmitted to one or more of the team members. The rating request may be sent to each team member of the project, or targeted to specific team members, such as the team member submitting the most recent progress report. A rating completed by a team member may include a subjective evaluation of another team member, such as a score. A completed rating may comprise other components, such as a rating commentary. Ratings may be completed and received by the project management application. Using one or more ratings from the same team member or different team members, an organization synergy value associated with the team member is generated. The synergy value may quantify how well two team members work with each other. Later, when a new project is created, a list of team members may be generated based in part on the synergy values of each member.

### Illustrated Methods

The success of an organization is built around the ability of its members to work together to achieve the organization's goals. Two critical components of organization success and team building are an understanding of the individual strengths and weaknesses of each organization member along with accurate forecasting of how well different organization members will work together. By generating organization synergy values that reflect the compatibility of different organization members, or the compatibility of an organization member with different types of projects, project organizers may harness the latent intuition of an organization to build better teams.

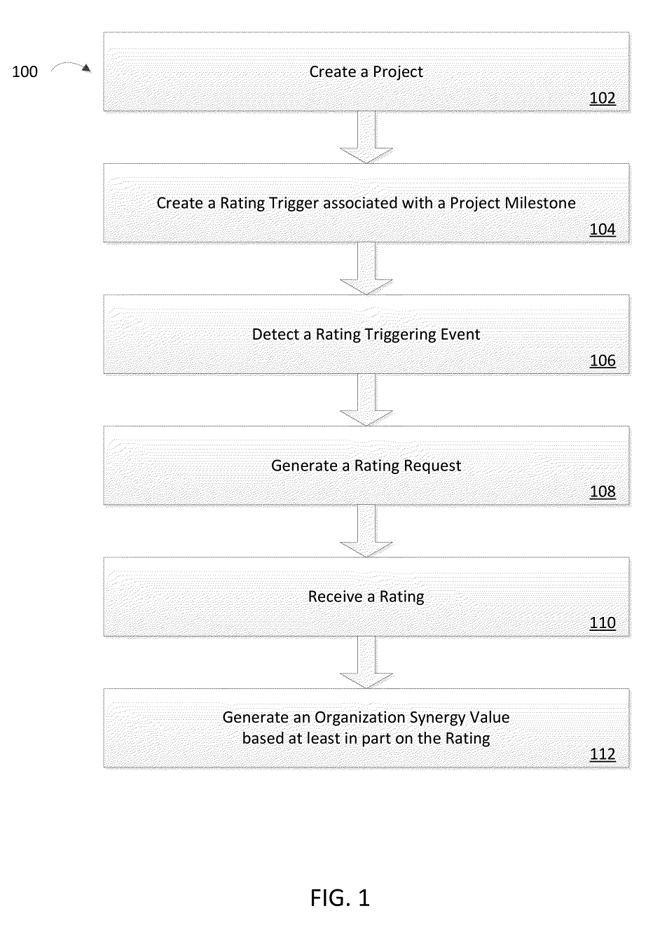

FIG. 1 illustrates a flow diagram of method 100 according to one embodiment for generating organization synergy values. In step 102 of method 100, a project is created. A project may be conceptualized within the Goals Objectives Strategies Plans Actions (“GOSPA”) strategic model. In the GOSPA strategic model, a project may coincide with a plan, and the project may comprise one or more sub-components, such as actions. Additionally, in the GOSPA strategic model, a project may be associated with one or more higher level strategic components, such as a goal, objective, or strategy. In other embodiments, a project may coincide with a different strategic model or no strategic model at all.

A project may comprise one or more project elements. Examples of project elements include, without limitation, a project stakeholder, a project category, a project task, or a project deadline. A project stakeholder may be an individual, group of individuals, or an organization associated with and/or affected by a project. Examples of project stakeholders may include a project organizer, project manager, project members (i.e. team members), and third parties affected by a project, such as a client or customer. In one embodiment, a project comprises a plurality of project stakeholders, including a project manager, a plurality of team members, and a project customer. In another embodiment, project stakeholders include a manager responsible for tracking the project and an organization member assigned to complete the project.

The performance of project members may be measured by analyzing the success and/or failure of a project, on a global scale, or on a smaller more granular scale, such as the completion of individual tasks. Additionally, performance of project members may be measured by collecting ratings from project members and/or project subjects.

A project element may comprise one or more project categories. A project category may comprise a project type or general project subject matter such as “engineering”, “human resources” or “information technology.” As one alternative, a project category may comprise a skill related to the project, such as a programming language or technology platform associated with the overall project, or one or more project tasks.

Another example of a project element is a task. Embodiments of a project may comprise a single discrete task, a collection of related tasks, or even a defined series of ordered tasks. A task may be specific and measurable. The progress of the project as a whole may be tracked by measuring the completion percentage of individual tasks of the project. A project completion percentage may represent a completion amount of various project sub-components, such as tasks.

A project element may also comprise a deadline, such as an expected completion date. A project may comprise one or more deadlines. A final project deadline may comprise an expected completion date for all tasks of a project. Other deadlines associated with the project may comprise earlier deadlines, such as an activity deadline for one or more project activities.

A project may be created and tracked in a project management application. A project management application may track completion of project elements, and update the status of the project. Information about the project may be received from project stakeholders, such as the project organizer, team members, and customers or clients. In one embodiment, a project is created in a project management application, which later receives project updates, such as status reports, from team members, and automatically updates the progress of the project. The project management application may track progress toward certain project milestones, such as a project duration (e.g. one month, six weeks, one quarter, etc.) or a completion amount (e.g. 25%, 50%, 90%, etc.).

In step 104 of method 100, a rating trigger is created. In an embodiment, a project management application tracks a project, and a rating trigger associated with the project may be created in the project management application. A rating trigger may be created while a project is being created. Alternatively, a rating trigger may be added to a project while the project is ongoing.

A rating trigger may be associated with an individual project. For example, a project specific rating trigger may be tied to completion of a specific task associated with an existing project. In another embodiment, a rating trigger may be associated with a plurality of projects. For example, a rating trigger may comprise a global rating trigger. A quarterly rating trigger for collecting ratings every quarter may be created in a project management application.

A rating trigger may be associated with a project milestone. Examples of project milestones include, without limitation, a task milestone, a progress milestone, duration milestone, or event milestone. A task milestone may occur when a particular task or activity occurs, or is completed. For a software project, a task milestone may comprise completion of a particular aspect of the software, or completion of initial testing of the code. A progress milestone may comprise a predetermined project completion amount, such as 25%, 33%, 50%, 75%, or 100%. In one example, a rating trigger is set for when a project is completed, i.e. reaches 100% completion.

A duration milestone may comprise a predetermined project duration, such as one week, two weeks, one month, two months, one quarter, etc. A duration-based rating trigger may occur a limited (e.g. once) or unlimited number of times (e.g. periodically for the duration of the project). In one example, a rating trigger is set for every two weeks of a project. In another example, a rating trigger is set to an estimated project completion date. An event milestone may comprise a predetermined event associated with the project. A rating trigger may be set to when a call center receives a 100^{th} call, or when a software program is accessed a predetermined number of times.

A rating trigger may be set to occur randomly, or pseudo-randomly. A random or pseudo-random rating trigger may be set to go off at any point during a project, independent of how long a project has lasted, or semi-randomly, such as at some random point three or more weeks into a project. A random or pseudo-randomly occurring rating trigger may elicit more spontaneous, less expected ratings.

In the embodiment of FIG. 1, the rating trigger is associated with a project milestone. In other embodiments, a rating trigger may not be associated with a project. A rating trigger may be associated with an action, a task, an event, a person, or a resource. As examples, a rating trigger may be associated with a meeting, an office building, or a document. An organization may desire to track the synergy between organization members and such meetings, locations, or resources.

In step 106 of method 100, a rating triggering event is detected. In one embodiment, a project management application may automatically detect a rating triggering event. The project management application may track one or more project milestones, such as progress or duration, and detect when the project reaches a rating trigger set to a predetermined project milestone.

A progress-based project milestone may comprise a predetermined project completion percentage of the project, such as 25%, 33%, 50%, 66%, 75%, 90%, or 100%. Reaching the predetermined project completion percentage may automatically trigger a rating request. In one example, a rating trigger comprises a progress milestone set to 50% completion of a project. During the project, team members update the project status through status reports submitted to a project management application. A rating triggering event may be detected by the project management application when it is calculated that the project is halfway done (i.e. 50% completed).

A duration-based project milestone may comprise a period of time, such as two weeks, a month, a quarter, or some other time duration of a project. A task-based milestone may comprise a particular task of a project. In another embodiment, a rating trigger comprises a periodic trigger set to one month. A project management application may track the project, and detect the rating trigger every month after the project begins.

A rating triggering event may occur without an associated rating trigger. In one embodiment, a rating triggering event comprises a manual event. A manual rating triggering event may be initiated by an organization member such as a project organizer or project manager. The project manager may consider a particular moment to be a good milestone for collecting ratings from one or more project members, or a project member may independently request a rating form. In another embodiment, an unsolicited rating may be received independent of a rating trigger. For example, a customer may submit a rating independent of a prompt or rating request.

In some embodiments, a ratings triggering event may not be associated with a project. In one example, a ratings triggering event may comprise a periodic time interval, such as a month or a quarter. An application such as an organization hierarchy application may periodically generate a rating request for one or more organization members, independent of any project at a predetermined time interval.

A rating triggering event may be associated with a rating subject, i.e. a subject to be rated. A rating triggering event may be associated with a project element, such as a project goal, a project stakeholder, project category, project action, or project task. A rating triggering event may be associated with other rating subjects, such as an organization member, organization resources, such as buildings or conference rooms, or events, such as a conference.

A rating triggering event may be detected based on a predetermined progress or completion percentage of a project or task. For example, a rating triggering event may be detected when a project is completed or a meeting is concluded. Or, a rating triggering event may be detected when a project reaches some other predetermined progress level or completion percentage, such as 25%, 33%, 50%, 66%, 75%, or 90%. In some cases, a rating, or a project evaluation, may be more useful during a project than after. In other cases, a project evaluation may be most useful after a project is completed.

After a rating triggering event is detected, in step 108 a rating request may be generated. A rating request may comprise a request, or solicitation, for one or more people to submit a rating. In one embodiment, generating a rating request causes a rating solicitation, such as a rating form, to be transmitted to one or more people.

In one embodiment, a rating triggering event is associated with a project. After a rating triggering event associated with a project is detected, a rating request may be transmitted to one or more project stakeholders. In another embodiment, a rating triggering event is not associated with a project. After such a rating triggering event is detected, a rating request may be sent to a person associated with the rating triggering event, such as an entire department or organization.

A rating request may be transmitted to one or more people selectively, or broadcast to a group of people. A rating request may be targeted to specific organization members, such as a team member associated with a rating triggering event, or a team. A rating request may be broadcast to a group of people. For a rating triggering event associated with a progress milestone, an entire team may receive a rating request. For a rating triggering event associated with a duration milestone, an entire department may periodically receive a rating request. People outside of an organization hierarchy, such as customers or clients, may also receive a rating request. For example, a customer service user may receive a rating request after interacting with an organization's customer service department.

A rating request may comprise a link to a rating form, or cause a rating form to be displayed. In one example, a rating request comprises an email including a link to a web-accessible ratings form. In another example, a rating request comprises a trigger of a rating form displayed in a native device application, such as an organization hierarchy program or a project management application.

In step 110 of method 100, a rating is received. A rating may be received from a rator such as a project stakeholder. A project stakeholder may comprise an individual involved in or affected by a project. A project stakeholder may comprise an organization member, such as a project manager, team member, or department head. A project stakeholder may not be an organization member. For example, a project stakeholder may comprise an external customer or client.

A rating may comprise one or more subjective evaluations, or measures, of a project, an event (e.g. a meeting, conference), a resource (e.g. a software package, office, or building), another person (e.g. a team member, manager, department head), or a group of people (e.g. a team, department). A rating may comprise a quantitative aspect, such as a numerical value. In one embodiment, a rating comprises a number associated with a rating scale, such as a 1 to 4 scale, negative 5 to 5 scale, 1 to 10 scale, or a 0 to 100 scale.

A rating may comprise a qualitative aspect, such as a rating narrative. A rating narrative may be analyzed to determine additional information about a rating. For example words with positive or negative connotations may be identified and assigned a quantitative value, or used to adjust a quantitative value provided as part of a rating.

In step 112 of method 100 an organization synergy value is generated. An organization synergy value may reflect how well two organization components work with each other. In one embodiment, an organization synergy value may reflect how well an organization member submitting a rating (i.e. the rator) works with the subject of the rating (i.e. the rating subject). In such an embodiment a rating subject may comprise another organization member, or another organization component, such as a project, a project type, an event, or an organization resource. An organization synergy value may be associated with the rator and the rating subject. Thus an organization synergy value may reflect the synergy, or compatibility, between two organization components.

Synergy values, or organization synergy values, may be used to assign projects and create teams well suited to work with each other and matched to the task at hand. According to various embodiments organization synergy values may be generated from ratings received from organization members, or even from outside an organization. An organization hierarchy application may track organization components, including projects, members, and organization resources, and generate synergy values, or synergy ratings, between different organization members. During or after projects, organization members may be prompted to rate the project and their teammates. Such ratings may signify how well team members work with each other and/or on specific types of projects.

An organization synergy value may be correlated with a discrete point in time, such as the synergy between two organization members based on their individual ratings of each other after a project is completed. In another embodiment, an organization synergy rating may be updated over time, and dynamically reflect the synergy between organization components. As new ratings are received on an ongoing basis, the organization synergy values associated with the organization components may be updated. Such dynamic organization synergy values may be analyzed to determine trends, such as how well two organization members work together over multiple projects, or how well a project progressed from beginning to end.

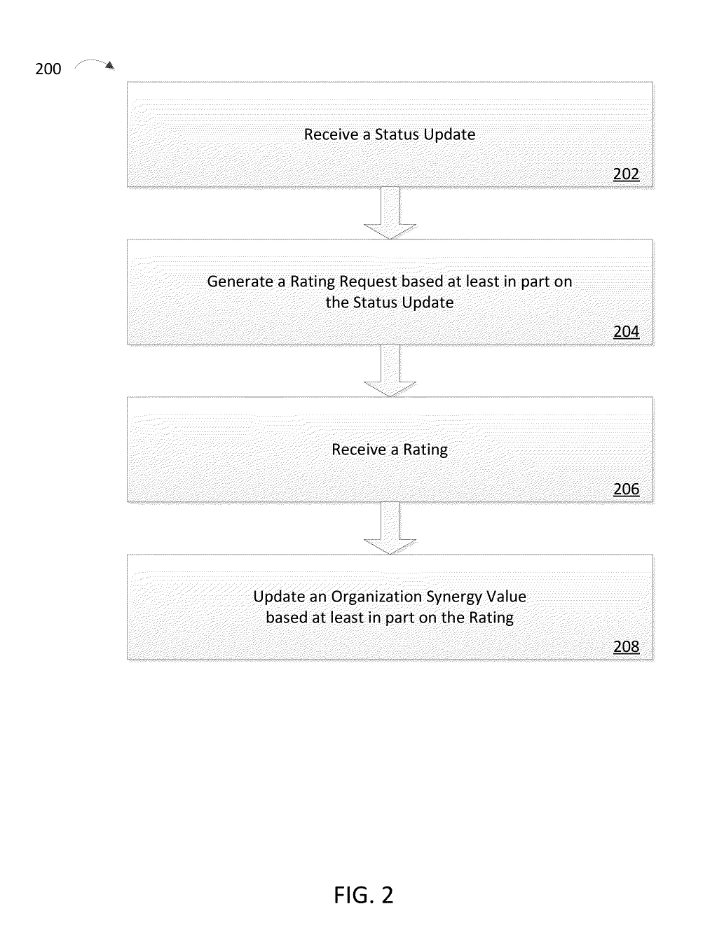

In an embodiment, a project is created, and during the project an organization synergy value is created based on an initial rating. Later, the organization synergy value may be updated based on subsequently received ratings. FIG. 2 illustrates a flow diagram of method 200 according to one embodiment. In step 202, a status update is received. A status update may be received directly from an application executing on a client, such as a native-client organization hierarchy application or web browser, or indirectly, such as through email. Status reports may be received on a regular basis, for example, on a daily, weekly, or monthly basis. In one alternative, status reports may be received on an irregular basis.

In an embodiment, a status update may be associated with an organization member submitting the status update. A status update may be associated with one or more projects. Some organization members may be simultaneously engaged on multiple projects. An organization member may submit individual status updates for each project in the same communication. Or, an organization member engaged in multiple projects may submit individual status updates for each project.

In step 204 of method 200, a rating request is generated based at least in part on the status update. A status update may indicate passage of a project milestone and trigger a rating request. In one embodiment a rating trigger may be set to a project progress milestone in a project management application. Later the project management application may receive a status update indicating progress surpassing the progress milestone. As a result, project management application may detect a rating triggering event based on the status update.

A status update may indirectly trigger a rating request. A status update may be received by an organization hierarchy application that tracks organization components. The status update may include information about an unrated organization component. In response, the organization hierarchy application may generate a rating request based on the unrated organization component information.

Independent of its contents, the act of submitting a status update may trigger a rating request. Submitting a status update may indicate that an organization member is available to complete a rating, and that it is an advantageous time to request a rating from that organization member, since they may be working on administrative tasks.

In step 206, a rating is received. Ratings may be directly received over the web, via email, or through a native device application, such as an iOS application or an Android application. The rating may be associated with the person submitting the rating, i.e. the rator. The status update may be associated with one or more subjects, such as a project, and the rating may be associated with the same project.

In step 208, an organization synergy value is updated based at least in part on the rating. A rating may be evaluated based on its perceived significance, and weighted accordingly. More recent ratings may be weighted more heavily than less recent weightings. In one alternative, a rating received during a project (before the project is completed) may be weighted more heavily than a rating received long after a project is completed. In another alternative, some or all ratings may be weighted the same. Other factors may affect the perceived relevance of a rating. A rating by one team member of another team member during a project may have a higher significance than a rating by one organization member of another organization member during a routine annual review.

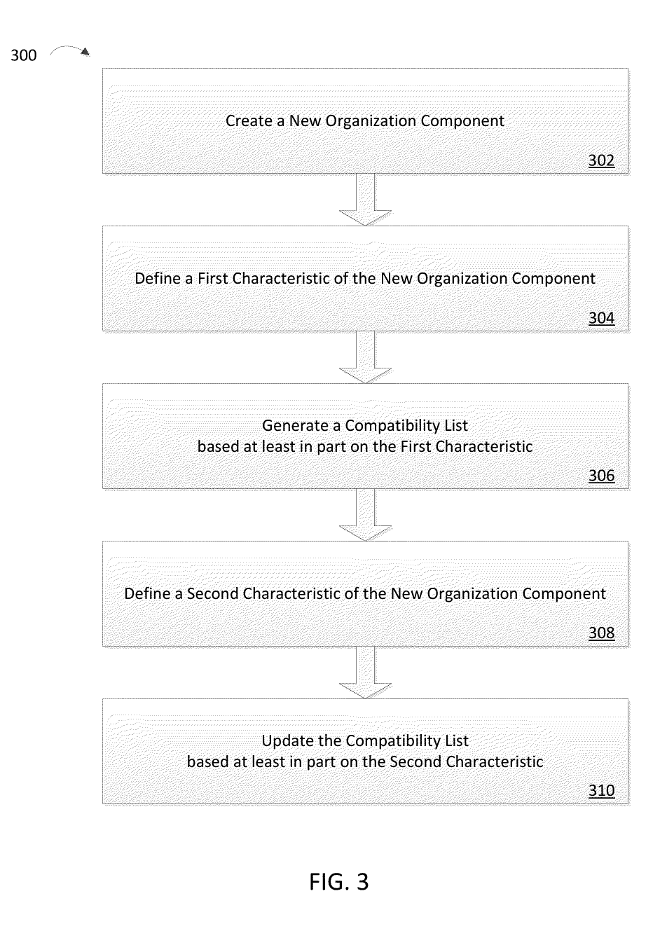

When a new organization component is created, a suggested list of organization members may be generated based on organization synergy values. In one embodiment, an organization component in the form of a new project is created, and one or more characteristics are specified about the project. Organization members with high organization synergy values with one or more of the characteristics may be determined, and included on a list of suggested project members. FIG. 3 illustrates a flow diagram of method 300 according to one embodiment. In step 302 of method 300, a new organization component is created. The new organization component may be created in an organization hierarchy application or a project management application, for example. A project may be created from scratch, cloned, copied, or imported from an existing or completed project, or created from a template.

An organization component may comprise a new strategic component, such as a goal, object, strategy, plan, action, task, or project. A new organization component may comprise a new organization member, i.e. a job requisition. A new organization component may appear in an organization as an empty, or blank organization component. In one embodiment, a new organization member may be inserted into a particular position in an organization hierarchy, and initially appear as an empty organization member in the hierarchy.

An organization component may be associated with other new or existing organization components. In one embodiment, a new project may be created, and associated with one or more lower-level strategic planning components, such one or more tasks. The new project may also be associated with one or more higher level strategic components, such as a goal or objective. In another embodiment, a new organization

In step 304, a first characteristic of the new organization component is defined. A characteristic of an organization component may comprise information associated with the new organization component, such as an existing organization component, or some other detail, such as a name or deadline. Characteristics of a new organization member may include an existing department or desired skills, education, and/or certifications. Characteristics of a new project may include an associated goal, objective, and/or task, a project manager, a project member, or a project deadline.

The first characteristic may be manually specified by a user. In an example, a user may create a new project and manually specify a project manager and one or more project members for the new project. Or, the user may specify a project category for the project and a due date, without specifying a manager or a project member.

A characteristic or a new organization component may be automatically determined. In one embodiment, a project may be created from a template, and automatically associated with certain pre-defined characteristics, such as a project leader, an organization department, or a strategic objective.

A characteristic of a new organization component may comprise an existing organization component which may be associated with one or more existing synergy values. For example, a manager may be specified for a new project. That manager may be associated with a plurality of organization synergy values based on reviews from former project members. Some project characteristics may not be associated with an organization synergy value. As one example, a project characteristic may comprise a deadline. A deadline, or expected completion date, may not be associated with an organization synergy value.

In step 306, a compatibility list is generated based at least in part on the first characteristic. A compatibility list may comprise one or more organization members with a high organization synergy value with the project characteristic. In one embodiment, a new project is created, and a project manager is defined for the new project. In the embodiment, a compatibility list may be generated based on organization members with a high organization synergy value with the newly defined project manager.

In one embodiment a project manager and a project category are specified as characteristics for a new project. A compatibility list may be generated including one or more organization members having a high organization synergy value with the project manager or the project category. Organization members with high organization synergy values with both the project manager and the project category may be the most compatible with the project, and may appear at the top of a compatibility list.

A compatibility list may be generated based on a project characteristic that does not have an existing organization synergy value. In one example, a project is created with an immediate or short-term deadline. Such a project characteristic may call for organization members with synergy values that reflect speedy and/or efficient work-as well as organization members with immediate availability.

In step 308, a second characteristic of the new organization component is defined. In one embodiment, a new projected is created. During creation of the project, or while the project is in progress, new characteristics about the organization component may be defined, and existing characteristics may be changed or deleted. A project manager may specify additional characteristics by adding organization members to the project team, specifying additional skills for the project, or adding tasks to the project. A project manager may also modify one or more characteristics of the project, for example, by removing organization members from the project team, deleting project activities, and changing a project deadline.

In another embodiment, a new organization component is created in the form of a job requisition for a new employee. Initial characteristics of the job requisition may comprise the manager of the new employee and one or more desired skills. Later, as potential responsibilities of the new employee become clear, characteristics of the job requisition may be updated, by adding certifications and skills or even changing the employee's manager.

In step 310, the compatibility list is updated based at least in part on the second project characteristic. As characteristics about the organization component are added, updated, changed, or even deleted, the most compatible organization members may fluctuate. In an embodiment, as a team for a project is formed, a compatibility list of suggested team member may be updated as team members are added to the project, and additional project details are specified.

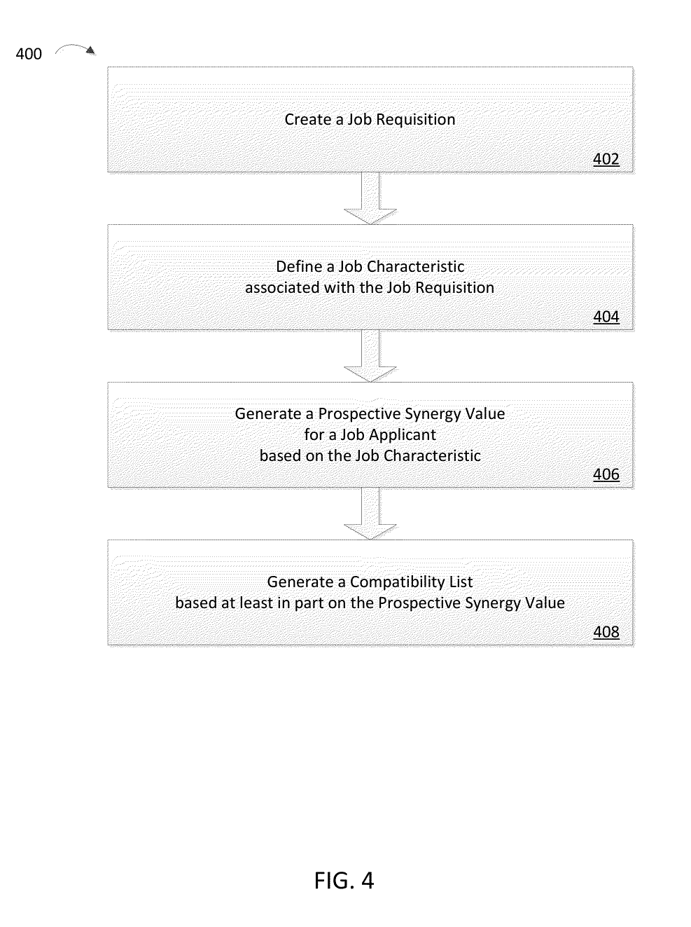

When organizations determine the necessity to hire additional personnel, the hiring process may frequently be imprecise. Embodiments may advantageously leverage existing organization synergy values to analyze job applicants, generate prospective synergy values, and rank job applicants according to the highest perspective synergy values. FIG. 4. Illustrates a flow diagram of method 400 according to one embodiment. In step 402 of method 400, a job requisition for a new employee is created. A job requisition may be created in an organization hierarchy application. A job requisition may be associated with an existing organization component, such as an ongoing project or an existing department. Such existing organization components may suggest predefined characteristics for a job requisition. As one alternative, a new job requisition may be created with little or no predefined characteristics.

In step 404, a job characteristic associated with the job requisition is defined. A job characteristic may be automatically defined. In one embodiment, a job requisition is created for a specific opening on an existing team or department. One or more job characteristics, such as the existing team manager or skills common to the existing team or department may be automatically defined for the job requisition.

A job characteristic may be manually defined by a user. A user may define a job characteristic for a new position in an organization by specifying one or more desired and/or necessary characteristics of job applicants, such as skills, experience, certification, or experience. A user may further rank or order a plurality of characteristics in order of importance.

In step 406, a prospective synergy value is generated for a job applicant based at least in part on the job requisition. In one embodiment, a job applicant may submit a resume comprising one or more applicant characteristics, such as skills, certifications, experience and education of the job applicant. One or more of the applicant characteristics may be analyzed and compared against characteristics of existing organization members (e.g. the skills, certifications, experience, and education of existing organization members) to generate a prospective synergy value. Additional criteria may be manually or automatically specified to generate a prospective synergy value. As one example, an organization member may indicate that they have worked with a job applicant in the past, and provide a general rating of that job applicant. Such a general rating may be taken into account when generating a prospective synergy value.

When a pool of job applicants are considered for a position, a prospective synergy values may be generated for each job applicant. The pool of job applicants may then be sorted by highest prospective synergy values. In step 408 of FIG. 4, a compatibility list is generated based at least in part on the prospective synergy value. A job applicant compatibility list may be automatically sorted according to the highest prospective synergy values of the job applicants.

### Illustrated System

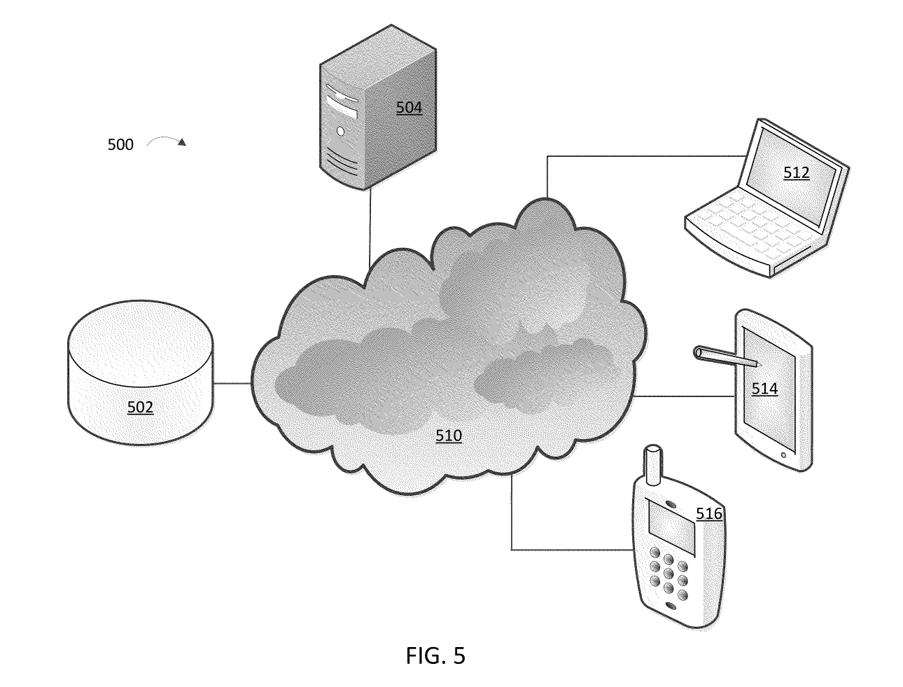

FIG. 5 is a diagram of a system 500 according to another embodiment. As shown in system 500, client devices 512, 514, 516 may be in communication with server 504 over network 510. Server 504 and/or client devices 512, 514, 516 may also be in communication with database 502.

As shown in FIG. 5, client devices include laptop computer 512, tablet 514 and smart phone 516. In other embodiments, other types of client devices may be used. Client devices 512, 514, 516 may execute an organization hierarchy application that may generate a graphical user interface. An organization hierarchy application may comprise a native mobile device application such as an iOS iPad application, a Windows Phone application, or an Android application. As one alternative, the application may comprise a non-native application such as a web application accessed through a web browser, for example from a desktop computer or a laptop. An application executing on client device 512, 514, 516 may receive a rating request, display a rating form, and transmit a rating completed by a user.

Server 504 may detect a rating triggering event and transmit a rating request to client device 512, 514, and/or 516. A rator, such as a user of a client device, may submit a rating on a client device, which may be transmitted over network 510 and received by server 504. A rating may be associated with the user submitting the rating, i.e. the rator. The rating may comprise a score, or a quantified measure of a rating subject, such as another organization member, a group of organization members, a project, an event, or a resource. After receiving one or more ratings, server 504 may generate an organization synergy value associated with the rator and the rating subject, and store the synergy value on database 502. Later, server 504 may update an organization synergy value based on new ratings associated with the rator and the rating subject.

### Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art rely after having the benefit of this description of the invention. Changes may be made in the elements described herein without departing from the spirit and scope of the invention as described above and below.

What is claimed is:

1. A method for generating an organization synergy value, comprising:
creating a project in a project management application;
creating a rating trigger associated with the project;
detecting a rating triggering event;
generating a rating request;
receiving a rating of a project element from a rator; and
generating an organization synergy value based at least in part on the rating, wherein the organization synergy value is associated with the rator and the project element.

2. The method of claim 1, wherein the organization synergy value comprises a numerical representation of how compatible the rator is with the project element.

3. The method of claim 1, wherein the ratings triggering event comprises a predetermined project duration or a project completion percentage.

4. The method of claim 3, wherein the project completion percentage is 25%, 33%, 50%, 66%, 75%, 90%, or 100%.

5. The method of claim 1, wherein the rating comprises a rating score of the project element.

6. The method of claim 1, wherein the rating comprises a rating narrative.

7. The method of claim 1, wherein the rator comprises a project stakeholder.

8. The method of claim 7, wherein the project stakeholder comprises a project organizer, project manager, project team member, project client, or project consumer.

9. The method of claim 1, wherein the rator comprises a first project team member, and the synergy value is associated with the first project team member and a second project team member.

10. The method of claim 9, wherein the rating comprises a first rating, and further comprising:
receiving a second rating from the second project team member, the second rating associated with the first project team member; and
updating the organization synergy value based on the second rating.

11. The method of claim 1, wherein the rating triggering event comprises a first rating triggering event and the rating request comprises a first rating request, and further comprising:
detecting a second rating triggering event;
transmitting a second rating request to the rator;
receiving a second rating from the rator; and
updating the organization synergy value based on the second rating.

12. A method for ranking job applicants, comprising:
creating a job requisition;
defining a job characteristic associated with the job requisition; and
generating a prospective synergy value associated with a job applicant based at least in part on the job characteristic.

13. A method for creating a cohesive project team, comprising:
creating a new organization component;
defining a characteristic of the new organization component; and
generating a compatibility list based at least in part on the characteristic.

14. The method of claim 13, wherein the new organization component comprises a project.
